(19) United States
(12) Patent Application Publication
(10) Pub. No.: US 2011/0236104 A1
(43) Pub. Date: Sep. 29, 2011

(54) TAPE PRINTING APPARATUS, CHARACTER ARRANGEMENT DECIDING MEHTOD FOR TAPE PRINTING APPARAUS, AND PROGRAM FOR THE SAME

(75) Inventor: Shoji Takayama, Azumino-shi (JP)

(73) Assignee: Seiko Epson Corporation, Tokyo (JP)

(21) Appl. No.: 13/046,123

(22) Filed: Mar. 11, 2011

(30) Foreign Application Priority Data
Mar. 24, 2010 (JP) 2010-067229

(51) Int. Cl. B41J 5/30

(52) U.S. Cl. 400/61

(57) ABSTRACT

A tape printing apparatus includes: a paragraph creating unit which creates a paragraph including plural lines of character strings; a justification setting unit which sets justification to evenly allocate other lines to the same length as a longest line, of the plural lines in the paragraph; a character mode setting unit which sets a non-target range to be a non-target of the justification, on a character basis within the paragraph, and sets a length of character spacing within the non-target range; a character arrangement deciding unit which carries out justification based on the justification setting unit in a target range excluding the non-target range set by the character mode setting unit, and thus decides an arrangement of characters in each line included in the paragraph; and a printing unit which prints the paragraph on a tape with the character arrangement decided by the character arrangement deciding unit.

### BACKGROUND

1. Technical Field

The present invention relates to a tape printing apparatus that can create a paragraph including plural lines of character strings and print the paragraph on a tape, a character arrangement deciding method for the tape printing apparatus, and a program for the same.

2. Related Art

Traditionally, a tape printing apparatus of this kind can provide several paragraphs on one label and thus can provide various different numbers of lines or change design for each paragraph. Also, justification is known as an attribute (paragraph style) that can be set for each paragraph. This justification is the function of aligning other lines to the length of the longest line in the paragraph, for example, as described in the User's Manual of “TEPRA” PRO SR930 by KING JIM, July 2009, Third Edition, pages 73, 82.

When this justification function is used, if different lines have different numbers of characters, there is a problem that the character spacing spreads in a line with a small number of characters, thus spoiling the appearance. FIG. 8A shows the result of printing a label L where the first line “ [symbol] ” (YAMADA TARO) is justified in a similar layout to the second line “ [symbol] ” (SATO KOTARO) (“_” indicating a halfwidth space). In this manner, since the first line has a smaller number of characters than the second line, the first line looks sparse as a whole.

Thus, even in the case where a paragraph is justified, the justification of the character spacing between some characters that look sparse can be canceled (made non-target), thus narrowing the character spacing to improve the appearance. FIG. 8B shows the result of printing a label L where the justification of the character spacing between “ [symbol] ” (YAMA) and “ [symbol] ” (DA) and between “ [symbol] ” (TA) and “ [symbol] ” (RO) in the first line “ [symbol] ” (YAMADA TARO) is canceled.

However, the tape printing apparatus described in the User's Manual of “TEPRA” PRO SR930 by KING JIM, July 2009, Third Edition, pages 73, 82, cannot provide other setting than “close” character spacing for the character setting in which justification is canceled. Therefore, there are only two options, that is, making character strings within the paragraph a target of justification or making the character strings as a non-target of justification. The characters within the paragraph cannot necessarily be arranged as desired by the user. That is, in the example shown in FIG. 8A and FIG. 8B, the character spacing between “ [symbol] ” (YAMA) and “ [symbol] ” (DA) and between“ [symbol] ” (TA) and “ [symbol] ” (RO) in the first line “ [symbol] ” (YAMADA TARO) cannot be made narrower than in FIG. 8A and cannot be made longer than in FIG. 8B, either, even if the user wants such setting.

### SUMMARY

An advantage of some aspects of the invention is that a tape printing apparatus having a high degree of freedom for the character arrangement within a paragraph, a character arrangement deciding method for the tape printing apparatus, and a program for the same can be provided.

According to an aspect of the invention, there is provided a tape printing apparatus including: a paragraph creating unit which creates a paragraph including plural lines of character strings; a justification setting unit which sets justification to evenly allocate other lines to the same length as a longest line, of the plural lines in the paragraph; a character mode setting unit which sets a non-target range to be a non-target of the justification, on a character basis within the paragraph, and sets a length of character spacing within the non-target range; a character arrangement deciding unit which carries out justification based on the justification setting unit in a target range excluding the non-target range set by the character mode setting unit, and thus decides an arrangement of characters in each line included in the paragraph; and a printing unit which prints the paragraph on a tape with the character arrangement decided by the character arrangement deciding unit.

According to another aspect of the invention, there is provided a character arrangement deciding method for a tape printing apparatus that can print a paragraph including plural lines of character strings. The method includes allowing the tape printing apparatus to: create the paragraph; set justification to evenly allocate other lines to the same length as a longest line, of the plural lines in the paragraph; set a non-target range to be a non-target of the justification, on a character basis within the paragraph, and set a length of character spacing within the non-target range; and carry out justification based on the justification setting in a target range excluding the non-target range that is set, and thus deciding an arrangement of characters in each line included in the paragraph.

With these configurations, in a non-target range to be a non-target of justification set for a paragraph, the length of character spacing can be set on a character basis. Therefore, the degree of freedom for character arrangement within the paragraph can be enhanced. Thus, even when the character spacing is excessively expanded by the justification of the paragraph, a range covering the unfitting part can be set as a non-target range and the character spacing within this range can be set to a desired length. Therefore, characters in each line included in the paragraph can be arranged with proper appearance.

In the tape printing apparatus, it is preferable that the character mode setting unit selects a length of character spacing within the non-target range from plural candidates representing relative lengths.

With this configuration, the length of character spacing can be selected from plural candidates such as “close”, “narrow”, “normal” and “wide”. Thus, even a beginner can easily set the length of character spacing.

In the tape printing apparatus, it is also preferable that the character mode setting unit sets a character mode setting target character either as a starting character of the non-target range or as a starting character of the target range, as the setting of the non-target range.

With this configuration, a non-target range (and a target range) can be set by character mode setting for each character. For example, in a character string “ABCDE”, if the character “B” is set as the starting character of the non-target range, the character strings from “B” becomes the non-target range. Thus, the invention can be realized simply by adding an option whether to make a character or characters a target of justification or not, to a character mode menu.

In the tape printing apparatus, it is also preferable that the character arrangement deciding unit carries out the justification using the spacing between each character within the target range and a character immediately before the each character.

With this configuration, for example, in the case where a character string “BCD” as a part of a character string “ABCDE” is set as a target range, justification can be realized using the spacing between “A” and “B”, between “B” and “C”, and between “C” and “D”. Since there is no character immediately before the leading character in each line (the first character), the leading character does not become a target of justification even if this character is set as a target range.

According to still another aspect of the invention, there is provided a program causing a computer to execute each operation of the character arrangement deciding method for the tape printing apparatus.

Using this program, a character arrangement deciding method for a tape printing apparatus with a high degree of freedom for character arrangement in a paragraph can be realized.

### BRIEF DESCRIPTION OF THE DRAWINGS

The invention will be described with reference to the accompanying drawings, wherein like numbers reference like elements.

FIG. 1 is a perspective view showing the appearance of a tape printing apparatus according to an embodiment of the invention.

FIG. 2 is a control block diagram of the tape printing apparatus.

FIG. 3 is a screen transition view showing a series of operations from the creation of a paragraph to the allocation.

FIG. 4A to FIG. 4D are explanatory views showing the result of printing a label.

FIG. 5A to FIG. 5C are explanatory views showing the setting of a character mode for each character, the number of dots allocated to each character, and a calculation formula for the same.

FIG. 6 is a flowchart showing paragraph allocation by the tape printing apparatus.

FIG. 7 is a flowchart showing line allocation by the tape printing apparatus.

FIG. 8A and FIG. 8A are explanatory views showing the result of printing a label according to a traditional technique.

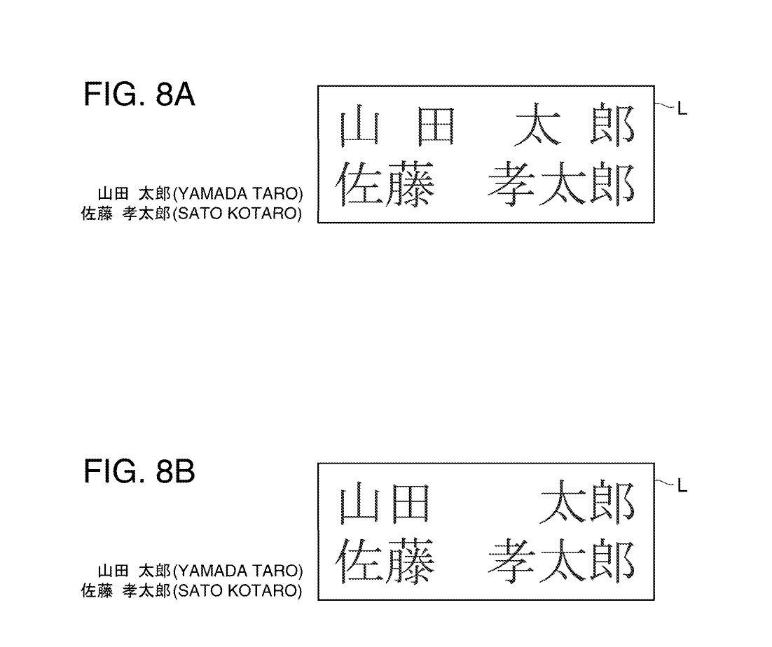

### DESCRIPTION OF EXEMPLARY EMBODIMENTS

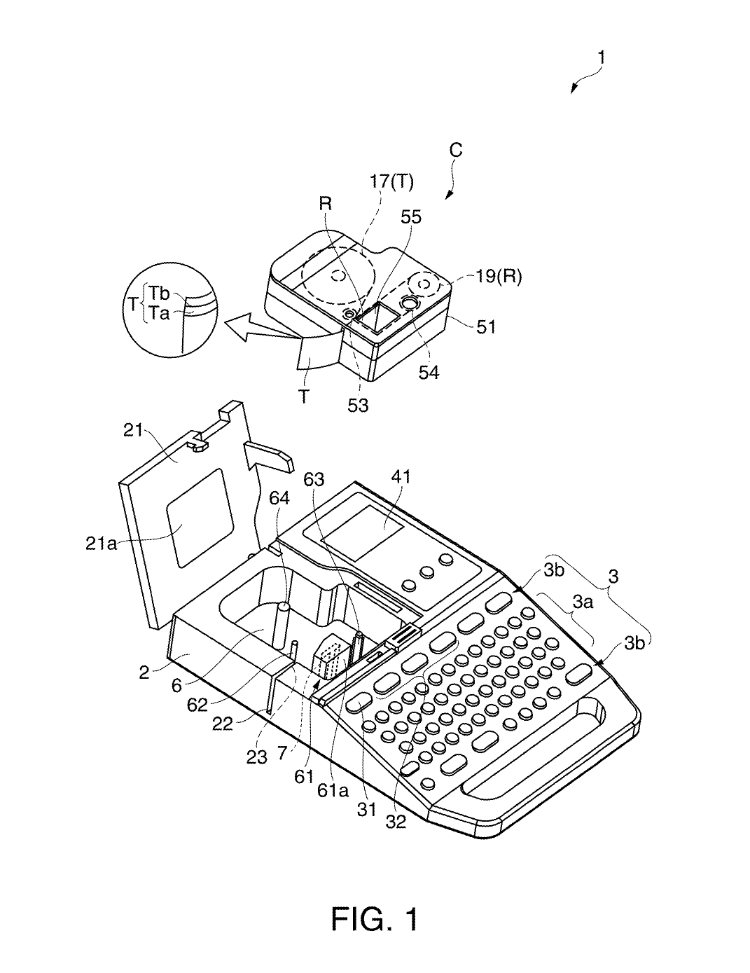

Hereinafter, an embodiment of the invention will be described with reference to the accompanying drawings. FIG. 1 is a perspective view showing the appearance of a tape printing apparatus 1 according to this embodiment, with its open/close cover 21 opened. As shown in FIG. 1, the contour of the tape printing apparatus 1 is formed by an apparatus case 2. A keyboard 3 having various input keys is arranged on the top side of a front part of the apparatus case 2. The open/close cover 21 is attached to a left part on the top side of a rear part. A display screen 41 is arranged to the right of the open/close cover 21. Inside the open/close cover 21, a cartridge loading section 6 for loading a tape cartridge C is formed as a recess. The tape cartridge C is removably loaded in the cartridge loading section 6 in the state where the open/close cover 21 is opened. In the open/close cover 21, a viewing window 21a is formed which allows visual recognition of loading or non-loading of the tape cartridge C in the state where the open/close cover 21 is closed.

A character key group 3a, and a function key group 3b to designate various operation modes or the like are arranged on the keyboard 3. The character key group 3a has a full key configuration based on the JIS arrangement. The character key group 3a is similar to the key configuration of a general word processor, including a shift key for restraining increase in the number of keys to be operated. The function key group 3b includes a “print” key, “cursor” keys, a “select” key, a “delete” key, and an “edit” key.

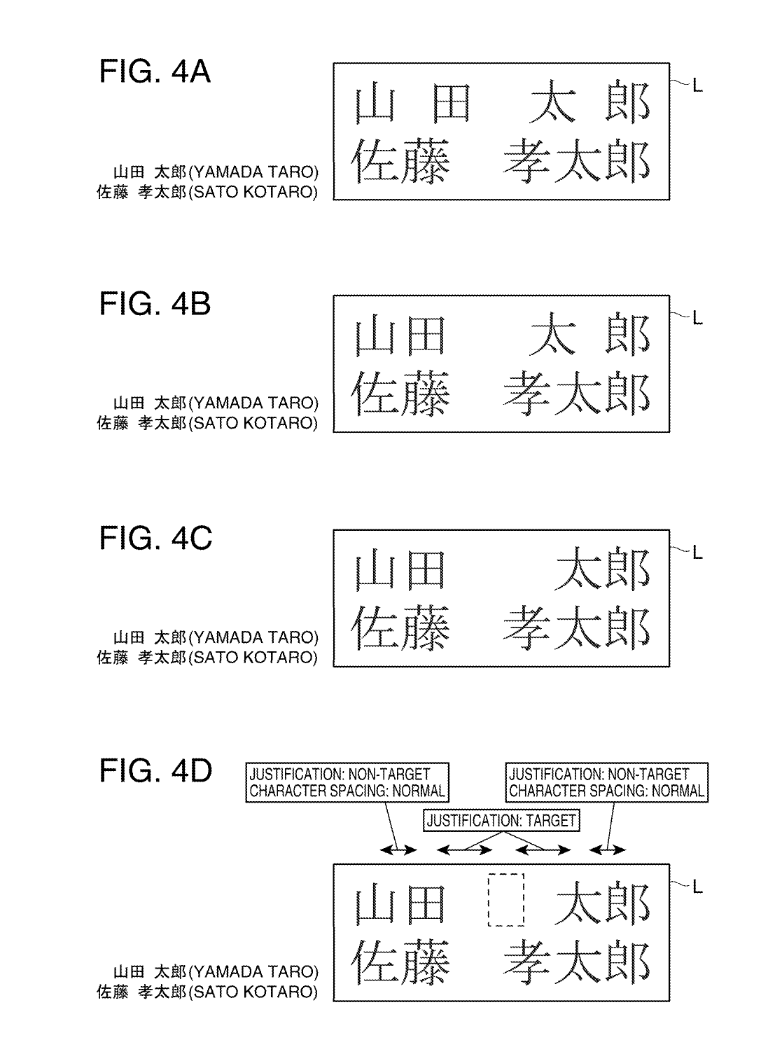

The “print” key is a key for designating the execution of printing. The “cursor” keys include up, down, left and right keys (“↑”, “↓”, “←”, “→”). These keys are for cursor movement and scrolling. The “select” key is a key for selecting and finalizing an option. The “delete” key is a key for deleting (or erasing) a character. The “edit” key is a key for setting a character mode, setting a paragraph style, setting a text format, and the like. A “paragraph” refers to an “aggregate of lines (or one line)” printed in a way that these lines are stacked to the tape width. A “text” refers to all the paragraphs, all the lines and all the characters printed on one label L (see FIG. 4A to FIG. 4D). That is, the size of each unit is in ascending order of “character<line<paragraph<text”.

The display screen 41 is a liquid crystal display and is used by the user when confirming an editing result based on input information inputted via the keyboard 3 and print data or the like generated on the basis of the editing result.

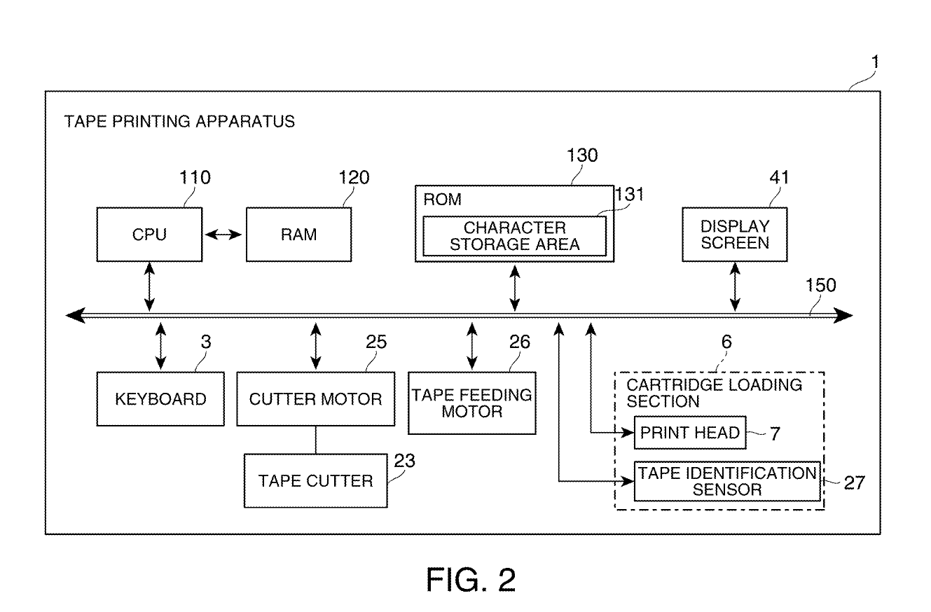

A tape discharge port 22 connecting the cartridge loading section 6 to outside is formed at a left-side part of the apparatus case 2. In the tape discharge port 22, a tape cutter 23 for cutting a tape T that is sent out exists. The tape T that is already printed is sent out by a predetermined length from the tape discharge port 22. In the state where the sending of the tape is temporarily stopped, the printed tape T is cut by the tape cutter 23. Thus, a stripe-like label L is created (see FIG. 4A to FIG. 4D). For the cutting processing, whether to drive a cut motor 25 (see FIG. 2) can be set according to the option to “carry out” or “not to carry out” automatic cutting.

In the cartridge loading section 6, a head unit 61 having a thermal print head 7 built in a head cover 61a, a platen drive shaft 62 facing the print head 7, a reel-in drive shaft 63 which reels in an ink ribbon R, which will be described later, and a positioning protrusion 64 for a tape reel 17, which will be described later, are provided. A tape feeding motor 26 (see FIG. 2) which rotates the platen drive shaft 62 and the reel-in drive shaft 63 is built in a part below the cartridge loading section 6.

The tape cartridge C houses a tape reel 17 on which the tape T with a predetermined width (approximately 4 to 48 mm) is wound, at a top central part within a cartridge case 51, and a ribbon reel 19 on which the ink ribbon R is wound, at a bottom right part. The tape T and the ink ribbon R have the same width. A through-hole 55 in which the head cover 61a covering the head unit 61 is to be inserted is formed at a left part below the tape reel 17. With the head unit 61 inserted in the through-hole 55, a platen roller 53 which is engaged with the platen drive shaft 62 and thus rotationally driven is arranged corresponding to the part where the tape T and the ink ribbon R overlap each other. Meanwhile, a ribbon reel-in reel 54 is arranged closely to the ribbon reel 19. The ink ribbon R reeled off from the ribbon reel 19 is arranged to surround the head cover 61a and becomes reeled in by the ribbon reel-in reel 54.

When the tape cartridge C is loaded in the cartridge loading section 6, the head cover 61a is inserted in the through-hole 55, the position protrusion 64 is inserted in the center hole of the tape reel 17, and the reel-in drive shaft 63 is inserted in the center hole of the ribbon reel-in reel 54. The print head 7 is abutted against the platen roller 53, with the tape T and the ink ribbon R nipped between the print head 7 and the platen roller 53. Thus, printing becomes available. After that, as the user inputs a desired text (characters including letters, numbers, symbols and simple patterns) or image via the keyboard 3 while confirming the result of editing on the display screen 41 and then presses the “print” key to designate printing, the tape printing apparatus 1 reels off the tape T from the tape cartridge C by the tape feeding motor 26 and causes a heat generating element of the print head 7 to selectively generate heat, thus performing desired printing on the tape T. The printed part of the tape T is sent outside, as required, from the tape discharge port 22. When the printing is completed, the tape feeding motor 26 feeds the tape T to a position where a tape length including a margin is obtained. After that, the tape feeding motor 26 stops the feeding (and then the apparatus shifts to cutting processing).

Meanwhile, the tape T includes a recording tape Ta having an adhesive layer formed on its back side, and a separation tape Tb pasted to the recording tape Ta by the adhesive layer. The tape T is wound in the shape of a roll with the recording tape Ta facing outside and the separation tape Tb facing inside, and is housed in the cartridge case 51. Different types of tapes T (with different tape widths, tape background colors, background patterns, materials and the like) are prepared. One of these types of tapes T (or ink ribbons R) is housed in each cartridge case 51. On the back side of the cartridge case 51, plural holes (not shown) to specify the type of the tape cartridge C are provided. In the cartridge loading section 6, plural tape identification sensors (micro-switches or the like) 27 (see FIG. 2) to detect the plural holes are provided corresponding to the plural holes. As the tape identification sensors 27 detect the state of the plural holes, the tape type can be determined.

Next, the control configuration of the tape printing apparatus 1 will be described with reference to the control block diagram of FIG. 2. The tape printing apparatus 1 has a CPU (central processing unit) 110, a RAM (random access memory) 120, a ROM (read only memory) 130, the display screen 41, the keyboard 3, the cutter motor 25, the tape cutter 23, the tape feeding motor 26, the print head 7, and the tape identification sensors 27. These components are connected via a bus 150.

The RAM 120 is directly connected with the CPU 110 and is used as a work area when the CPU 110 carries out various kinds of control. The ROM 130 stores control programs and various kinds of information for carrying out various kinds of control. Specifically, as the control programs, a display control program to control the display on the display screen 41, a paragraph creation processing program to create a paragraph, a paragraph allocation processing program to carry out allocation processing within a paragraph, a print processing program to carry out print processing, and the like are stored (not shown). The ROM 130 also has a character storage area 131 in which many characters used for the display on the display screen 41 and the print on the tape T are stored.

The display screen 41 functions as a display unit to display the result of editing and print layout. The keyboard 3 functions as an input unit for the user to input information, an editing unit to carry out editing processing, a setting unit to carry out various kinds of setting, and the like.

The cutter motor 25 is connected with the tape cutter 23 and functions as a cutting unit. The tape feeding motor 26 and the print head 7 function as a printing unit to carry out printing on the tape T. As described above, the print head 7 and the tape identification sensors 27 are provided in the cartridge loading section 6. The tape identification sensors 27 detect the type of the tape T housed in the tape cartridge C. The CPU 110 controls the limitations to the number of lines and the number of characters that can be inputted as a text, the determination of compatibility of the loaded tape cartridge C, and the like, on the basis of the result of detection by the tape identification sensors 27 (on the basis of the tape width and the like). The CPU 110 also controls the display processing on the display screen 41, the editing processing and the print processing.

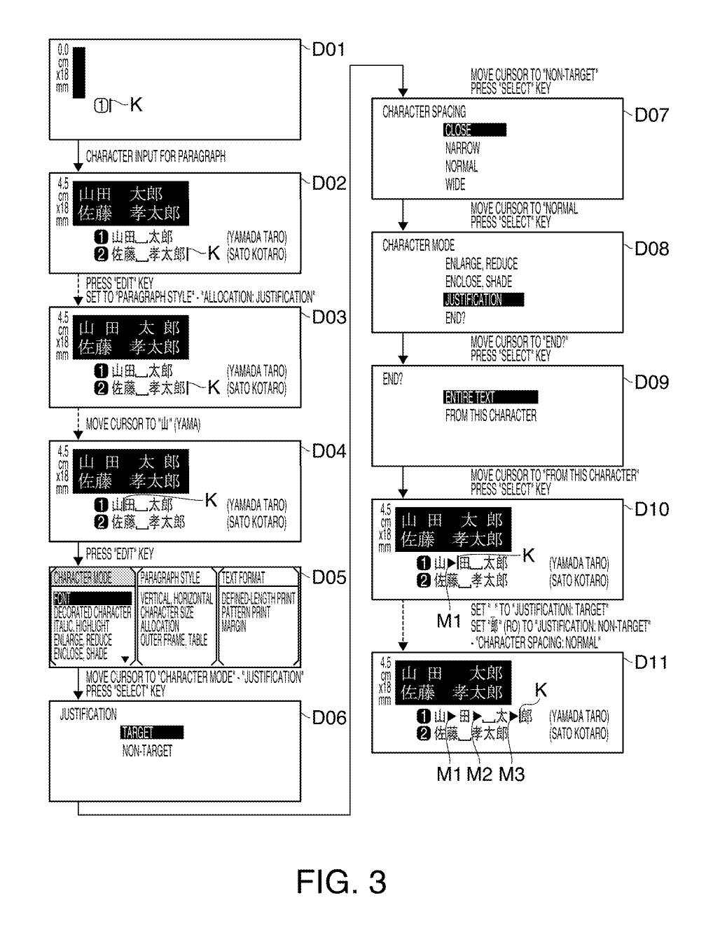

Next, the operations from the creation of a paragraph to the allocation, and the result of printing based on these operations will be described with reference to FIG. 3 and FIG. 4A to FIG. 4D. The screen indicated by a reference symbol D01 (hereinafter referred to as “screen D**”) shows a text input screen in a state where no input is made yet. In the text input screen in the state where no input is made yet, a cursor K is added to a beginning-of-line mark indicated by an enclosed number. The beginning-of-line mark displayed in white (the number representing the line number displayed in black) means that no character is inputted in this and subsequent lines. The beginning-of-line mark displayed in black (the number representing the line number displayed in white) means that characters are inputted in this and subsequent lines (see D02 or the like). On the bottom side of the text input screen, there is a text display area showing inputted texts. On the top side of the text input screen, there is a print preview area. Moreover, at a top left part of the screen, there is a size display area showing the size of a label L to be produced. For example, in the example shown in FIG. 3, since no input is made yet, it is shown that the tape length is 0.0 mm and the tape width is 18 mm on the basis of the result of detection by the tape identification sensors 27.

A screen D02 shows a state where characters of the first paragraph are inputted. Here, it is assumed that “ [symbol] [symbol] ” (YAMADA TARO) is inputted in the first line and “ [symbol] [symbol] ” (SATO KOTARO) is inputted in the second line (“_” meaning a halfwidth space) (paragraph creating unit). Here, if the “edit” key is pressed and “allocation: justification” is set as the paragraph style, the screen D03 is displayed (justification setting unit). In the screen D03, a state where other lines (in this example, the first line) are evenly allocated to the same length as the longest line (in this example, the second line) of the lines included in the paragraph, is displayed in the print preview area. The result of printing a label L that is produced when the “print” key is pressed in the state of the screen D03 is as shown in FIG. 4A. The setting of the paragraph style is not described in detail. However, this setting is carried out as an editing item selection screen shown in a screen D05 is displayed by the operation of the “edit” key.

Next, the operation to cancel, on a character basis, the justification set for the paragraph and then set character spacing will be described (character mode setting unit). If the cursor K is moved to the character “ [symbol] ” (YAMA) by the operation of the “cursor” keys in the state of the screen D03, a screen D04 is displayed. If the “edit” key is pressed in the state of the screen D04, the editing item selection screen (screen D05) is displayed. Here, if the cursor K is moved to “justification”, of the plural editing items in the character mode (font, decorated character, italic and highlight, enlarge and reduce, enclose and shade, justification, end?) and the “select” key is pressed, a justification setting screen (screen D06) is displayed. The justification setting screen is a screen for setting whether to make a particular part a target of the justification for the paragraph or not. That is, with the setting on this screen, it is possible to set a justification non-target range. Here, if the cursor K is moved to an item “non-target” and the “select” key is pressed, a character spacing setting screen (screen D07) is displayed.

The character spacing setting screen is a screen for setting character spacing in the case where the item “non-target” is selected on the justification setting screen.

In the character spacing setting screen, character spacing can be selectively set from among plural candidates indicating relative lengths. Here, if the cursor K is moved to an item “normal” and the “select” key is pressed, a screen D08 for selecting an item in the character mode is displayed. If the cursor K is moved to the item “end?” meaning the end of editing in the character mode, in the screen D08, and the “select” key is pressed, a screen D09 for selecting a valid range of the editing content is displayed.

In the screen D09, either an item “entire text” or an item “from this character” can be selected. For example, if “entire text” is selected, the editing content is reflected on the entire text. Meanwhile, if “from this character” is selected, the editing content is reflected on that character and the subsequent characters (the position of the cursor K and the subsequent part). That is, when the item “from this character” is selected, the character that is the setting target (in this example, “ [symbol] ” (DA)) is set as the starting character of a non-target range. If the item “target” is selected in the justification setting screen (screen D06) and the item “from this character” is selected in the screen D09, the character that is the setting target is set as the starting character of a target range.

If the cursor K is moved to the item “from this character” in the screen D09 and the “select” key is pressed, a text input screen of a screen D10 is displayed. In the screen D10, a character mode mark M1 (black right-pointing triangular mark) indicating that the character mode is set is displayed in the text display area. With this display, the user can confirm that the character mode is set on the character “ [symbol] ” (DA) and the subsequent characters. Also, in the screen D10, a state where the character spacing between the characters “ [symbol] ” (YAMA) and “ [symbol] ” (DA) is set to “normal” is displayed in the preview display area. The result of printing a label L that is produced in the case where the “print” key is pressed in the screen D10 is as shown in FIG. 4B.

A screen D11 is the display screen 41 (text input screen) after setting the character “_” to “justification: target” and setting the character “ [symbol] ” (RO) to “justification: non-target”—“character spacing: normal”, following the screen D05 to the screen D09. In the screen D11, three character mode marks M1, M2 and M3 indicating that the character mode is set are displayed in the text display area, and the result of the above setting is displayed in the preview display area. The result of printing a label L that is produced in the case where the “print” key is pressed in the screen D11 is as shown in FIG. 4C.

As shown in FIG. 4A to FIG. 4D, the result of printing shown in FIG. 4C has an improved appearance because the character spacing between “ [symbol] ” (YAMA) and “ [symbol] ” (DA) and between “ [symbol] ” (TA) and “ [symbol] ” (RO) in the first line “ [symbol] ” (YAMADA TARO) is narrower than in FIG. 4A where only justification for the paragraph is carried out. This improvement in appearance can be realized since the character spacing between “ [symbol] ” (YAMA) and “ [symbol] ” (DA) and between “ [symbol] ” (TA) and “ [symbol] ” (RO) is set to “justification: non-target” and further to “character spacing: normal”, as shown in FIG. 4D. In FIG. 4C, the character spacing between “ [symbol] ” (DA) and “_” (indicated by a dotted-line frame in FIG. 4C) and between “_” and “ [symbol] ” (TA), which is set to “justification: target”, is widened as the character spacing between “ [symbol] ” (YAMA) and “ [symbol] ” (DA) and between “ [symbol] ” (TA) and “ [symbol] ” (RO) is narrowed. Hereinafter, this allocation processing will be described in detail.

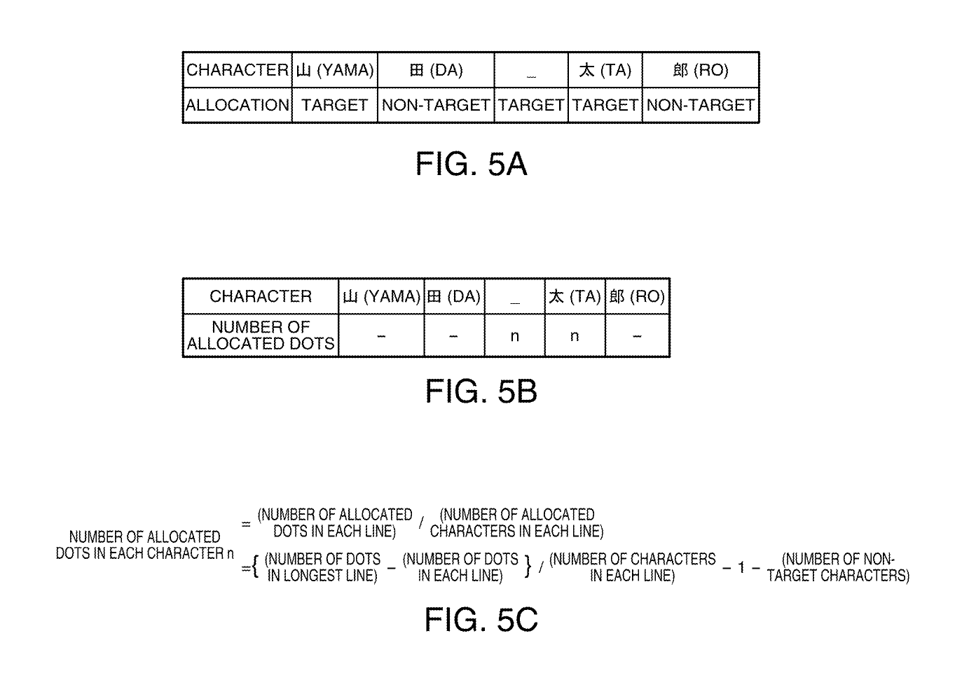

FIG. 5A shows the setting of the character mode “justification” for the first line “ [symbol] ” (YAMADA TARO) in the case where the setting shown in FIG. 3 is carried out. As described above, in the character mode, a target or non-target of justification for a paragraph can be set on a character basis. In the example shown in FIG. 3, the characters “ [symbol] ” (YAMA), “_” and “ [symbol] ” (TA) are set to “allocation: target” and the characters “ [symbol] ” (DA) and “ [symbol] ” (RO) are set to “allocation: non-target”. In the following description, a character set to “allocation: target” is referred to as a “target characters”, and a character set to “allocation: non-target” is referred to as a “non-target character”.

FIG. 5B shows the number of allocated dots that are allocated to each character in the first line “ [symbol] ” (YAMADA TARO) in the case where the setting shown in FIG. 3 is carried out. In this embodiment, the number of dots represents the length in the longitudinal direction of the tape T. The number of allocated dots represents dots allocated to target characters other than the leading character. Therefore, in the example shown in FIG. 3, n dots are allocated to each of the characters “_” and “ [symbol] ” (TA). That is, justification is carried out using the spacing between each character within the target range and the character immediately before this each character. Thus, since there is no character immediately before the first character of each line, the first character of each line does not become a target of justification even when this character is set within a target range. Therefore, even when the leading character is set as a target character as in this example, no dots are allocated to the leading character. Thus, misalignment of the head position from other lines and appearance and the resulting poor appearance can be prevented.

FIG. 5C shows a calculation formula for calculating the number of allocated dots n. As shown in FIG. 5C, the number of allocated dots n that are allocated to each character is the value of “the number of allocated dots in each line” divided by “the number of allocated characters in each line”. “The number of allocated dots in each line” is the number of dots obtained by subtracting the number of dots in each line from the number of dots in the longest line of the plural liens included in the paragraph. “The number of allocated characters in each line” is the number obtained by subtracting 1 from the number of characters in each line and then further subtracting the number of non-target characters from the result.

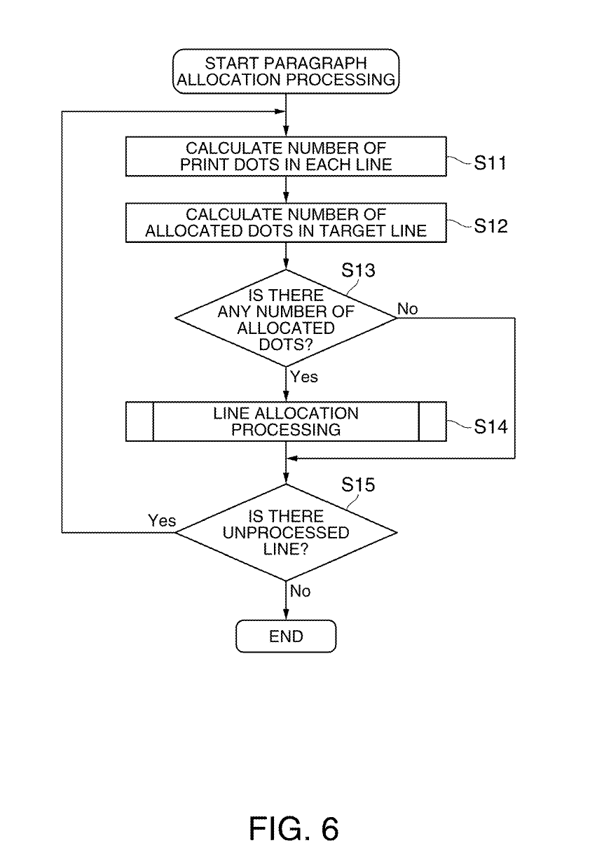

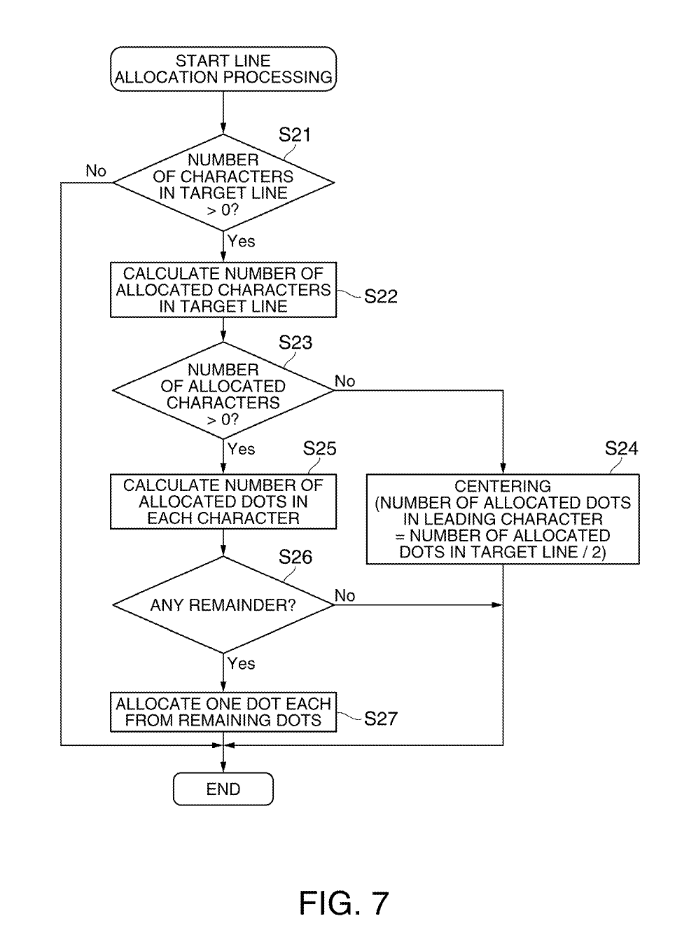

Next, allocation processing by the tape printing apparatus 1 (character arrangement deciding unit) will be described with reference to the flowcharts of FIG. 6 and FIG. 7. FIG. 6 is a flowchart showing paragraph allocation processing. The tape printing apparatus 1 (CPU 110) calculates the number of print dots in each line included in a paragraph (S11). Next, the tape printing apparatus 1 calculates the number of allocated dots in a target line to be a target of allocation (S12). The number of allocated dots in the target line is equivalent to “the number of allocated dots in each line shown in FIG. 5C. Here, if there is a certain number of allocated dots in the target line (Yes in S13), line allocation processing is carried out (S14). If there isn't any number of allocated dots in the target line (No in S13), S14 is omitted. After that, it is determined whether there is an unprocessed line or not (S15). If there is an unprocessed line (Yes in S15), the processing returns to S11. If there is no unprocessed line (No in S15), the paragraph allocation processing ends.

FIG. 7 is a flowchart showing the line allocation processing equivalent to S14 in FIG. 6. The tape printing apparatus 1 (CPU 110) determines whether the number of characters in the target line is greater than 0 or not (S21). If the number of characters in the target line is not greater than 0 (No in S21, there is no character in the target line), the line allocation processing ends. If the number of characters in the target line is greater than 0 (Yes in S21, there are characters in the target line), the number of allocated characters in the target line is calculated (S22). The number of allocated characters in the target line is equivalent to “the number of allocated characters in each line” shown in FIG. 5C.

After that, it is determined whether the number of allocated characters in the target line is greater than 0 or not (S23). If the number of allocated characters in the target line is not greater than 0 (No in S23, there is no allocated character), the target line is centered (S24). For example, a case where all the characters in the target line are set as non-target characters is equivalent to this case. In this case, the number of allocated dots in the leading character is calculated by dividing the number of allocated dots in the target line by 2.

Meanwhile, if the number of allocated characters in the target line is greater than 0 (Yes in S23, there are allocated characters), the number of allocated dots in each character is calculated (S25). The number of allocated dots in each character can be calculated according to the calculation formula shown in FIG. 5C. After that, it is determined whether there is any number of remaining dots or not (S26). If there is a certain number of remaining dots (Yes in S26), the remaining dots are allocated, one dot each, to each target character (each character spacing). That is, one dot each from the remaining dots is allocated to each of the characters “_” and “ [symbol] ” (TA), thus aligning the leading end and the terminal end of the line. This allocation means that the remaining dots are allocated to the two character spacings indicated as “justification: target” in FIG. 4C. If there isn't any number of remaining dots (No in S26), S27 is omitted and the line allocation processing ends.

As described above, with the tape printing apparatus 1 according to the embodiment, the length of character spacing can be set on a character basis in a non-target range to be a non-target of justification that is set for a paragraph. Therefore, the degree of freedom for the character arrangement within the paragraph can be enhanced. Thus, even in the case where the character spacing is excessively expanded by the justification of the paragraph, a range covering the unfitting part can be set as a non-target range and the character spacing within this range can be set to a desired length. Therefore, characters in each line included in the paragraph can be arranged with proper appearance. Moreover, since the length of character spacing can be selected from plural candidates indicating relative lengths such as “close”, “narrow”, “normal” and “wide”, even a beginner can easily set the length of character spacing.

In the embodiment, the character spacing can be selected from plural candidates indicating relative lengths. However, it is also possible to enable the setting of the character spacing by inputting numeric values (character mode setting unit). In this case, values may be inputted in any unit, for example, in inches, in millimeters, or in dots.

In the embodiment, in the case where “justification—non-target” is set in the character mode, the character spacing can be set as its lower hierarchical level (see the screen D06 and the screen D07 in FIG. 3). However, it is also possible to enable the setting of the character spacing as an editing item in the character mode. That is, it is possible to enable the selection of an editing item “character spacing” on the editing item selection screen (screen D05).

In the embodiment, justification is carried out using the spacing between each character within a justification target range and the character immediately before that character. However, the spacing between each character within a justification target range and the character immediately after that character may also be used. In other words, dots in the number of allocated dots may be allocated to the character spacing between a target character and the following character, instead of allocating the dots to the character spacing between the target character and the preceding character. It is also possible to enable the user to set whether to allocate the dots before or after the target character.

In the embodiment, as a method for setting a justification non-target range, in the case where the item “non-target” is selected on the justification setting screen (screen D06) and the item “from this character” is selected on the screen D09 for setting an effective range of the character mode, a character that is the setting target is set as the starting character of the non-target range. However, it is also possible to enable the setting of the ending character of the non-target range instead of the starting character of the non-target range. That is, in the case where the item “non-target” is selected on the justification setting screen (screen D06) and the item “to this character” is selected on the screen D09, a character that is the setting target may be set as the ending character of the non-target range.

In the embodiment, the start or end of a non-target range can be set on a character basis by the character mode setting for each character. However, it is also possible to enable the setting of the starting position and the ending position of the non-target range by a series of operations. That is, for the setting of the non-target range, the cursor K may be moved to designate the starting position and then the “cursor” keys may be operated to designate the ending position.

The components of the tape printing apparatus 1 described in the embodiment can be provided as a program. Also, the program stored in various recording media (CD-ROM, flash memory and so on) can be provided. That is, a program which causes a computer to function as each unit of the tape printing apparatus 1, and a recording medium in which this program is recorded should also be included in the scope of right of the invention. Moreover, various changes and modifications can be made without departing from the scope of the invention.

This invention can be used for a tape printer connected to a personal computer, the personal computer remotely control the tape printer.

The entire disclosure of Japanese Patent Application No. 2010-67229, filed Mar. 24, 2010, is expressly incorporated by reference herein.

What is claimed is:

1. A tape printing apparatus comprising:
a paragraph creating unit which creates a paragraph including plural lines of character strings;
a justification setting unit which sets justification to evenly allocate other lines to the same length as a longest line, of the plural lines in the paragraph;
a character mode setting unit which sets a non-target range to be a non-target of the justification, on a character basis within the paragraph, and sets a length of character spacing within the non-target range;
a character arrangement deciding unit which carries out justification based on the justification setting unit in a target range excluding the non-target range set by the character mode setting unit, and thus decides an arrangement of characters in each line included in the paragraph; and
a printing unit which prints the paragraph on a tape with the character arrangement decided by the character arrangement deciding unit.

2. The tape printing apparatus according to claim 1, wherein the character mode setting unit selects a length of character spacing within the non-target range from plural candidates representing relative lengths.

3. The tape printing apparatus according to claim 1, wherein the character mode setting unit sets a character mode setting target character either as a starting character of the non-target range or as a starting character of the target range, as the setting of the non-target range.

4. The tape printing apparatus according to claim 1, wherein the character arrangement deciding unit carries out the justification using the spacing between each character within the target range and a character immediately before the each character.

5. A character arrangement deciding method for a tape printing apparatus that can print a paragraph including plural lines of character strings, the method comprising:
creating the paragraph;
setting justification to evenly allocate other lines to the same length as a longest line, of the plural lines in the paragraph;
setting a non-target range to be a non-target of the justification, on a character basis within the paragraph, and set a length of character spacing within the non-target range; and
carrying out justification based on the justification setting in a target range excluding the non-target range that is set, and thus deciding an arrangement of characters in each line included in the paragraph.

6. A program causing a computer to execute the operation of the character arrangement deciding method for the tape printing apparatus according to claim 5.
